(19) United States
(12) Patent Application Publication
(10) Pub. No.: US 2023/0091474 A1
(43) Pub. Date: Mar. 23, 2023

(54) POWER SUPPLY CONVERSION TOPOLOGY OF MULTIPHASE SWITCH CAPACITOR RESONANT CAVITY CONVERSION CIRCUIT WITH FULL-WAVE OUTPUT RECTIFICATION AND POWER SUPPLY CONVERSION STRUCTURES BASED ON POWER SUPPLY CONVERSION TOPOLOGY

(71) Applicant: NANJING EFFICIENT POWER FOR INTELLIGENT COMPUTING TECHNOLOGIES CO. LTD., Nanjing (CN)

(72) Inventors: Hui ZHAO, Nanjing (CN); Yiran CHEN, Nanjing (CN)

(73) Assignee: NANJING EFFICIENT POWER FOR INTELLIGENT COMPUTING TECHNOLOGIES CO. LTD., Nanjing (CN)

(21) Appl. No.: 17/875,541

(22) Filed: Jul. 28, 2022

(30) Foreign Application Priority Data
Aug. 24, 2021 (CN) 202110972261.X

(51) Int. Cl. H02M 3/07; H02M 1/00

(52) U.S. Cl. CPC H02M 3/07; H02M 1/0058

(57) ABSTRACT

A power supply conversion topology of a multiphase switch capacitor resonant cavity conversion circuit with full-wave output rectification. The power supply conversion topology includes at least k conversion switch capacitors and one output switch capacitor which are sequentially connected in series through conductors and are connected to two ends of input power supply. When a transformer ratio N is an even number, k=N/2; when transformer ratio N is not an even number, k is smallest integral greater than N/2; and lower end of output switch capacitor is grounded, and two ends of output switch capacitor are connected with output interfaces. Power supply conversion topology further includes k switch resonant cavity converters. When transformer ratio N is even number, k=N/2; and when transformer ratio N is not even number, k is smallest integral greater than N/2. The invention further discloses two power supply conversion structures based on power supply conversion topology.

### TECHNICAL FIELD

The present invention relates to a power supply conversion structure, and more particularly relates to a power supply conversion topology of a multiphase switch capacitor resonant cavity conversion circuit with full-wave output rectification for distributed power supply systems and universal point-of-load applications and power supply conversion structures based on the power supply conversion topology.

### BACKGROUND

In a data center and an electric automobile, there is an increasing need for more efficient power supply conversion topologies from distributed power supply systems to point-of-load applications. An existing transformer circuit achieving the above functions, as shown in FIG. 1, includes a resonant cavity, a switch, a control logic, and one or more non-resonant capacitors. The control logic generates two or more groups of control signal inputs, these control signal inputs are applied to the switch input to form one or more sub-circuit loops for each group of control signals. Additionally, one or more sub-circuit loops are used for one or more sub-circuit loops of the first group of control signals different from the second group of control signals, each sub-circuit loop includes one or more resonant loops, and at least one sub-circuit loop includes one non-resonant capacitor. However, such a transformer has a complicated structure and high manufacturing cost.

### SUMMARY

The technical problem to be resolved by the present invention is to provide a power supply conversion topology of a multiphase switch capacitor resonant cavity conversion circuit with full-wave output rectification with a simple structure and low manufacturing cost.

To resolve the foregoing technical problem, the technical solution adopted in the present invention is as follows: a power supply conversion topology of a multiphase switch capacitor resonant cavity conversion circuit with full-wave output rectification is provided, including at least k conversion switch capacitors and one output switch capacitor which are sequentially connected in series through conductors, and are connected to two ends of an input power supply, where, when a transformer ratio N is an even number, k=N/2; when the transformer ratio N is not an even number, k is a smallest integral greater than N/2; and a lower end of the output switch capacitor is grounded, and two ends of the output switch capacitor are connected with output interfaces; and further including: k switch resonant cavity converters; where, when the transformer ratio N is an even number, k=N/2; and when the transformer ratio N is not an even number, k is a smallest integral greater than N/2; and

each of the switch resonant cavity converters includes an input assembly, an output assembly and a connecting assembly connected with the input assembly and the output assembly; the input assembly includes a first MOSFET switch and a second MOSFET switch connected in series through a conductor; the output assembly includes a third MOSFET switch and a fourth MOSFET switch connected in series through a conductor; the connecting assembly includes a resonant capacitor and a resonant inductor connected in series through a conductor; one end of the connecting assembly near the resonant capacitor is connected onto the conductor between the first MOSFET switch and the second MOSFET switch, and the other end of the connecting assembly is connected onto the conductor between the third MOSFET switch and the fourth MOSFET switch; each of the first MOSFET switch and the third MOSFET switch is provided with a first signal input end; each of the second MOSFET switch and the fourth MOSFET switch is provided with a second signal input end; the first MOSFET switch and the fourth MOSFET switch are switched on and off at a same time; the second MOSFET switch and the third MOSFET switch are switched on and off at a same time; and a quality factor Q of the switch resonant cavity converter satisfies 0.1≤Q≤10; the first MOSFET switch and the second MOSFET switch of the input assembly of the switch resonant cavity converter are respectively connected to two ends of each corresponding conversion switch capacitor; the fourth MOSFET switch of the output assembly of the switch resonant cavity converter is connected to the lower end of the output switch capacitor; and the third MOSFET switch of the output assembly of the switch resonant cavity converter is connected to an upper end of the output switch capacitor or an upper end of any one of other conversion switch capacitors of the corresponding conversion switch capacitors of the switch resonant cavity converter at one side near the output switch capacitor.

As a preferred solution, dead time, i.e., the time at which the first signal input end and the second signal input end are both off, and the first MOSFET switch, the second MOSFET switch, the third MOSFET switch and the fourth MOSFET switch are all on, exists between switch events in the switch resonant cavity converter.

As a preferred solution, the first MOSFET switch, the second MOSFET switch, the third MOSFET switch and the fourth MOSFET switch are all zero current switches.

As a preferred solution, a capacitance value of the conversion switch capacitor is one order of magnitude greater than a capacitance value of the resonant capacitor.

As a preferred solution, a capacitance value of the output switch capacitor is one order of magnitude greater than a capacitance value of the resonant capacitor.

Another technical problem to be resolved by the present invention is to provide a power supply conversion topology with a simple structure and low manufacturing cost.

To resolve the foregoing technical problem, the technical solution adopted in the present invention is as follows: a power supply conversion structure is provided, including at least two power supply conversion topologies of a multiphase switch capacitor resonant cavity conversion circuit with full-wave output rectification according to any one of the foregoing description disposed in a parallel connection manner.

To resolve the foregoing technical problem, another technical solution adopted in the present invention is as follows: a power supply conversion structure is provided, including at least two transformer assemblies connected in series, where each of the transformer assemblies includes one, two or more than two power supply conversion topologies of a multiphase switch capacitor resonant cavity conversion circuit with full-wave output rectification according to any one of the foregoing description disposed in a parallel connection manner.

To resolve the foregoing technical problem, another technical solution adopted in the present invention is as follows: a power supply conversion structure, including a power supply conversion assembly and a point-of-load conversion assembly connected in series, where the power supply conversion assembly includes a plurality of power supply conversion topologies of a multiphase switch capacitor resonant cavity conversion circuit with full-wave output rectification according to any one of the foregoing description disposed in a parallel connection manner, and the point-of-load conversion assembly includes a plurality of point-of-load converters disposed in a parallel connection manner.

The present invention has the beneficial effects that the power supply conversion topology is built on the basis of a circuit bearing structure, such as a printed circuit board, a silicon substrate or any other circuit bearing structures. The power supply conversion topology can be widely applicable to high-ratio DC-DC bus conversion without the need of current isolation for example, a data center, an electric automobile, a robot and a security and protection system. Compared with a solution in the prior art, the present invention has the advantages that the required voltage conversion ratio is achieved by using less devices in different combination modes between the resonant converter and the conversion switch capacitor. At the same time, due to the reduction of the total quantity of electronic devices, the BoM cost will be obviously reduced, and the large-scale mass production of products is facilitated.

Each single energy conversion sub-circuit loop in the power supply conversion topology is provided with an inductive impedance. Additionally, due to di/dt limitation of the inductive impedance, a flying capacitor is soft charged and discharged during normal operation. This overcomes inherent weakness of a conventional SCC (Switch Capacitor Converter) in which a heavy inrush current may be generated, momentarily resulting in charge redistribution loss and resulting in high switching loss and high RMS current loss. When switches of the power supply conversion topology clamp a drain-source voltage (Vds) during the off state, parasitic ringing between the resonant inductor and a switched junction capacitor will be eliminated, thus reducing stress on each of the switches. Additionally, benefiting from the resonant operation of the resonant cavity, controlling the on-off of the power supply conversion topology in a zero-current switching mode can be achieved, thus resulting in very low or negligible switching loss and very high efficiency through being compared with a switch without zero current. A cheaper and compacter solution is achieved, and simplicity, modularity and extendibility are provided.

Since the power supply conversion structure includes the power supply conversion assembly and the point-of-load conversion assembly which are connected in series, the power supply conversion assembly includes a plurality of power supply conversion topologies of a multiphase switch capacitor resonant cavity conversion circuit with full-wave output rectification disposed in a parallel connection manner, and the point-of-load conversion assembly includes a plurality of point-of-load converters disposed in a parallel connection manner, adoption of a two-stage conversion mode on a core rail, a memory rail and the like of a microprocessor (CPU, GPU, ASIC, etc.) is achieved. The first-stage bus converter steps down the voltage from input bus 48 V to middle bus 12 V through power supply conversion topology SCTC. Then, the single-phase or multiphase PoL is used for second-stage point-of-load power conversion.

### BRIEF DESCRIPTION OF THE DRAWINGS

FIG. 1 is a block diagram of a design of a double-transformer power supply.

FIG. 2 is a schematic diagram of a switch resonant cavity converter.

FIG. 3 is a 4-1 power supply conversion topology diagram.

FIG. 4 is a timing sequence diagram of switch control input signals of the power supply conversion topology diagram in FIG. 3 and current waveforms of circuits.

FIG. 5 is an 8-1 power supply conversion topology diagram.

FIG. 6 is another 8-1 power supply conversion topology diagram.

FIG. 7 is a 2-1 power supply conversion topology diagram.

FIG. 8 is a power supply conversion structure diagram.

FIG. 9 is a schematic diagram of a power supply conversion structure including a power supply conversion assembly and a point-of-load conversion assembly connected in series.

### DETAILED DESCRIPTION

The following describes specific embodiments of the present invention in detail with reference to accompanying drawings.

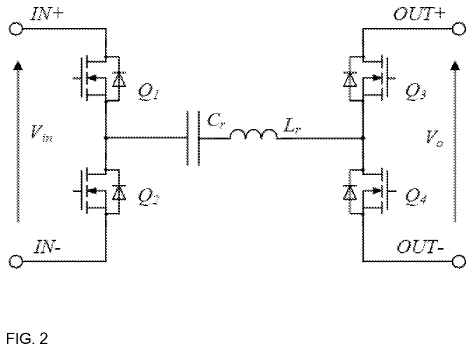

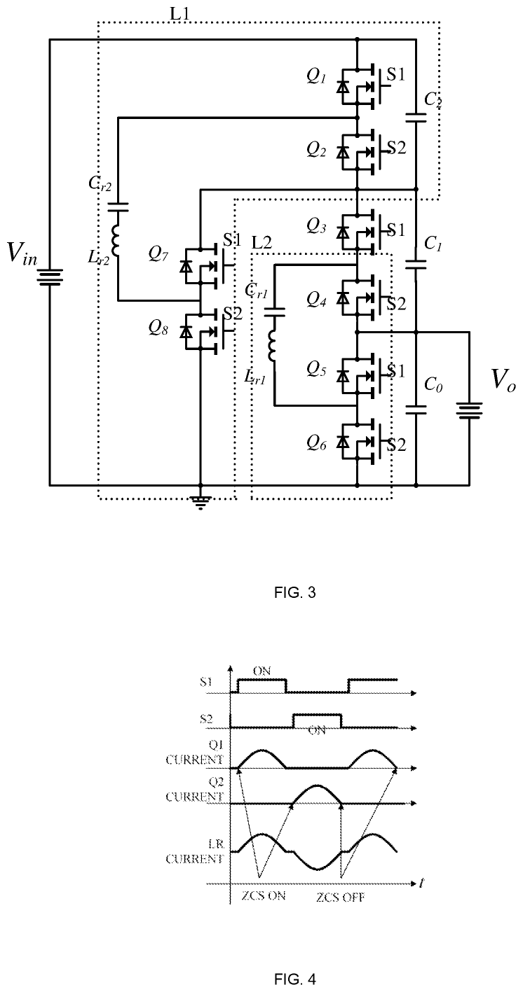

According to Embodiment 1, as shown in FIG. 2 to FIG. 3, a 4-1 power supply conversion topology of a multiphase switch capacitor resonant cavity conversion circuit with full-wave output rectification includes 2 conversion switch capacitors C1 and C2 and an output switch capacitor C0 which are sequentially connected in series through conductors, and are connected to two ends of an input power supply. A lower end of the output switch capacitor is grounded, and two ends of the output switch capacitor are connected with output interfaces. The power supply conversion topology further includes 2 switch resonant cavity converters L1 and L2.

The switch resonant cavity converter, as shown in FIG. 2, includes an input assembly, an output assembly and a connecting assembly connected with the input assembly and the output assembly. The input assembly includes a first MOSFET switch and a second MOSFET switch connected in series through a conductor. The output assembly includes a third MOSFET switch and a fourth MOSFET switch connected in series through a conductor. The connecting assembly includes a resonant capacitor and a resonant inductor connected in series through a conductor. One end of the connecting assembly near the resonant capacitor is connected onto the conductor between the first MOSFET switch and the second MOSFET switch, and the other end of the connecting assembly is connected onto the conductor between the third MOSFET switch and the fourth MOSFET switch. Each of the first MOSFET switch and the third MOSFET switch is provided with a first signal input end. Each of the second MOSFET switch and the fourth MOSFET switch is provided with a second signal input end. The first MOSFET switch, the second MOSFET switch, the third MOSFET switch and the fourth MOSFET switch are all zero-current switches. The first MOSFET switch and the fourth MOSFET switch are switched on and off at a same time. The second MOSFET switch and the third MOSFET switch are switched on and off at a same time. Moreover, a quality factor Q of the switch resonant cavity converter satisfies 0.1≤Q≤10.

Dead time, i.e., the time at which the first signal input end and the second signal input end are both off, and the first MOSFET switch, the second MOSFET switch, the third MOSFET switch and the fourth MOSFET switch are all on, exists between switch events in the switch resonant cavity converter.

A capacitance value of the conversion switch capacitor is one order of magnitude greater than a capacitance value of the resonant capacitor. A capacitance value of the output switch capacitor is one order of magnitude greater than a capacitance value of the resonant capacitor.

The first MOSFET switch and the second MOSFET switch of the input assembly of the switch resonant cavity converter Lj (j is 1 or 2) are respectively connected to two ends of each corresponding conversion switch capacitor Ci (i is 1 or 2). The fourth MOSFET switch of the output assembly of the switch resonant cavity converter Lj (j is 1 or 2) is connected to the lower end of the output switch capacitor. The third MOSFET switch of the output assembly of the switch resonant cavity converter L1 is connected to an upper end of the conversion switch capacitor C1. The third MOSFET switch of the output assembly of the switch resonant cavity converter L2 is connected to an upper end of the output switch capacitor C0.

During initial operation, the input voltage is equivalently divided into 3 parts of energy to be stored into each of the conversion switch capacitors C2 and C1 and the output switch capacitor C0. The switch resonant cavity converter L1 transmits the energy stored in C2 to C1 and C0 through a resonant cavity. The switch resonant cavity converter L2 transmits the energy stored in C1 to C0 through a resonant cavity. The final voltage transformation at the proportion of 4-1 from 48 V to 12 V is achieved.

The self synchronism needs to be maintained inside the resonant cavity of the circuit. However, a plurality of resonant cavities are independent of each other, and no synchronous relationship is required between the resonant cavities regardless of aspects of the period, the phase or the frequency.

There is a 180-degree phase shift between the first group of switch control signals S1 and the second group of switch control signals S2. The duty cycles of the two control signal inputs are identical or approximately identical. The switch resonant cavity converter of each energy conversion loop includes a resonant inductor and a resonant capacitor. When the switch is in an off state, the switch capacitors C1, C2 and C3 in the energy conversion loop are favorable for clamping the voltage across a switch terminal. The switches are controlled through the switch control signals S1 and S2 to be switched on or switched off at a zero current, i.e., ZCS (Zero Current Switching) is achieved. Compared with that in a state when the current flows in the switches, the switching loss can be reduced through the ZCS function.

The “on” and “off” time of each switching state depends on the resonant frequency of the resonant inductor and the resonant capacitor related in the specific switching state. Additionally, because the switch capacitors C1, C2 and C3 generally do not take part in the resonance, such capacitors can be reasonably regarded as voltage sources, and their influence on the resonant frequency is negligible. Under the ideal condition, the “conduction” time of the switching state equals to a half of the sinusoidal resonant cycle of an equivalent resonant circuit. Practically, some dampings are introduced to the resonant circuit due to presence of series resistors, the practical “conduction” time of each switching state may be adjusted to a value slightly deviating from a half of the sinusoidal resonant time cycle to achieve ZCS.

According to a timing sequence diagram shown in FIG. 4, switch input signals S1 and S2 and current waveforms of the first MOSFET switch Q1 and the second MOSFET switch Q2 in charging and discharging states are respectively shown. As shown in the timing sequence diagram, the switch timing sequence in the control signals S1 and the switch timing sequence in the control signals S2 are respectively switched to be “on” and “off” according to the resonant frequency. This is favorable for achieving ZCS, such as currents in the respectively shown first MOSFET switch Q1 and second MOSFET switch Q2 in charging and discharging states. The current obtained in the resonant loop is shown as LR current in the figure.

Dead time exists between all states. In this period, the control signals S1 and S2 are both in an “off” state. Additionally, all the switches of the circuit are in an off state. Under this condition, the respective duty cycles of the first group of control signals S1 and the second group of control signals S2 are lower than 50%. When all the switches are switched off, this dead time is generally minimum to adapt to current reset. Additionally, the ZCS may be achieved by setting the switching time of the two groups of control signals S1 and S2 to be about a half of the sinusoidal resonant cycle of the resonant loop and considering the resistance damping in a circuit element.

Since the capacitance of the switch capacitor is much higher than the capacitance of the resonant capacitor in the resonant cavity, the equivalent series capacitance is mainly determined by the smaller resonant capacitor.

It needs to be pointed out that the single conversion switch capacitor or the single output switch capacitor may also be replaced by a capacitor bank with the same capacitance value.

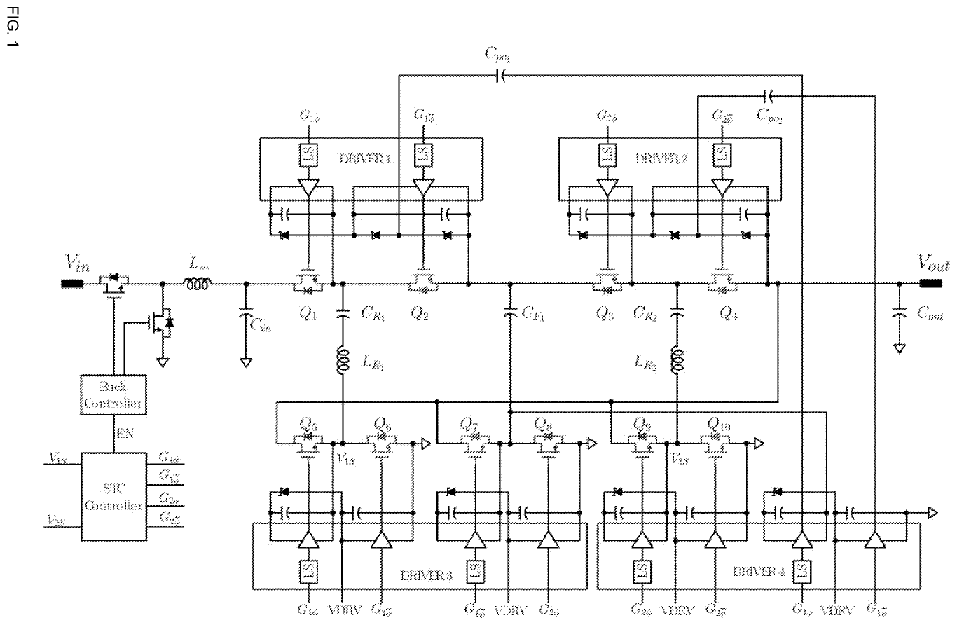

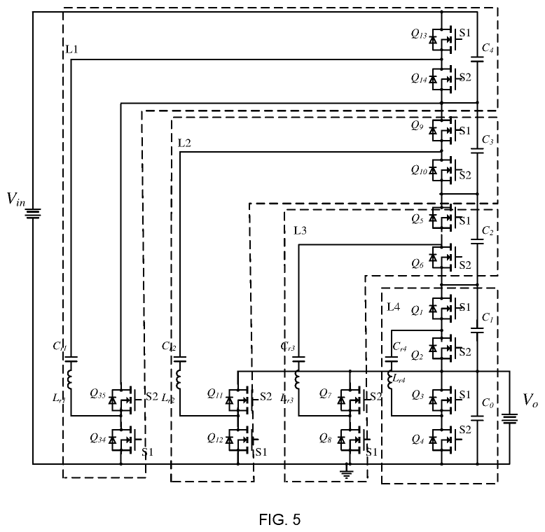

According to Embodiment 2, as shown in FIG. 1 to FIG. 6, an 8-1 power supply conversion topology of a multiphase switch capacitor resonant cavity conversion circuit with full-wave output rectification includes 4 conversion switch capacitors Ci (i is 1, 2, 3, . . . , 4) and an output switch capacitor C0 which are sequentially connected in series through conductors, and are connected to two ends of an input power supply. A lower end of the output switch capacitor is grounded, and two ends of the output switch capacitor are connected with output interfaces. The power supply conversion topology further includes 4 switch resonant cavity converters Lj (j is 1, 2, 3, . . . , 4).

The switch resonant cavity converter includes an input assembly, an output assembly and a connecting assembly connected with the input assembly and the output assembly. The input assembly includes a first MOSFET switch and a second MOSFET switch connected in series through a conductor. The output assembly includes a third MOSFET switch and a fourth MOSFET switch connected in series through a conductor. The connecting assembly includes a resonant capacitor and a resonant inductor connected in series through a conductor. One end of the connecting assembly near the resonant capacitor is connected onto the conductor between the first MOSFET switch and the second MOSFET switch, and the other end of the connecting assembly is connected onto the conductor between the third MOSFET switch and the fourth MOSFET switch. Each of the first MOSFET switch and the third MOSFET switch is provided with a first signal input end. Each of the second MOSFET switch and the fourth MOSFET switch is provided with a second signal input end. The first MOSFET switch, the second MOSFET switch, the third MOSFET switch and the fourth MOSFET switch are all zero-current switches. The first MOSFET switch and the fourth MOSFET switch are switched on and off at a same time. The second MOSFET switch and the third MOSFET switch are switched on and off at a same time. Moreover, a quality factor Q of the switch resonant cavity converter satisfies 0.1≤Q≤10.

Dead time, i.e., the time at which the first signal input end and the second signal input end are both off, and the first MOSFET switch, the second MOSFET switch, the third MOSFET switch and the fourth MOSFET switch are all on, exists between switch events in the switch resonant cavity converter Lj (j is 1, 2, 3, . . . , 4).

A capacitance value of the conversion switch capacitor is one order of magnitude greater than a capacitance value of the resonant capacitor. A capacitance value of the output switch capacitor is one order of magnitude greater than a capacitance value of the resonant capacitor.

The first MOSFET switch and the second MOSFET switch of the input assembly of the switch resonant cavity converter Lj are respectively connected to two ends of each corresponding conversion switch capacitor Ci. The fourth MOSFET switch of the output assembly of the switch resonant cavity converter Lj is connected to the lower end of the output switch capacitor C0. The third MOSFET switch of the output assembly of the switch resonant cavity converter L1 is connected to an upper end of the conversion switch capacitor C3. The third MOSFET switches of the output assemblies of the switch resonant cavity converters L2, L3 and L4 are connected to an upper end of the output switch capacitor C0.

During initial operation, the input voltage is equivalently divided into 5 parts, and the respective energy is stored into the conversion switch capacitors and the output switch capacitor.

Then, the switch resonant cavity converter L1 transmits the energy stored in C4 to C1, C2, C3 and C0 through a resonant cavity. The switch resonant cavity converter L2 transmits the energy stored in C3 to C0 through a resonant cavity. The switch resonant cavity converter L3 transmits the energy stored in C2 to C0 through a resonant cavity. The switch resonant cavity converter L4 transmits the energy stored in C1 to C0 through a resonant cavity The final voltage transformation at the proportion of 8-1 from 48 V to 6 V can be achieved.

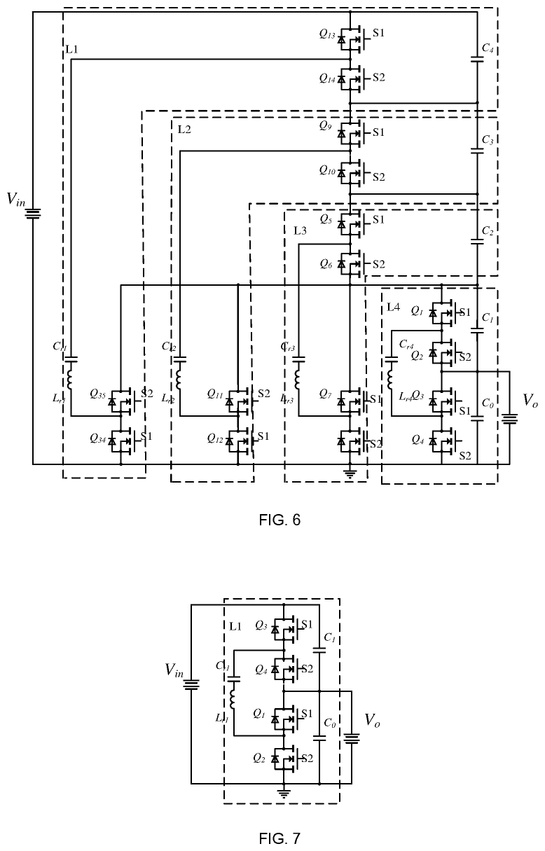

According to Embodiment 3, as shown in FIG. 6, an 8-1 power supply conversion topology of a multiphase switch capacitor resonant cavity conversion circuit with full-wave output rectification includes 4 conversion switch capacitors Ci (i is 1, 2, 3, 4) and an output switch capacitor which are sequentially connected in series through conductors, and are connected to two ends of an input power supply. A lower end of the output switch capacitor is grounded, and two ends of the output switch capacitor are connected with output interfaces. The power supply conversion topology further includes 4 switch resonant cavity converters Lj (j is 1, 2, 3, 4).

The switch resonant cavity converter Lj (j is 1, 2, 3, 4) includes an input assembly, an output assembly and a connecting assembly connected with the input assembly and the output assembly. The input assembly includes a first MOSFET switch and a second MOSFET switch connected in series through a conductor. The output assembly includes a third MOSFET switch and a fourth MOSFET switch connected in series through a conductor. The connecting assembly includes a resonant capacitor and a resonant inductor connected in series through a conductor. One end of the connecting assembly near the resonant capacitor is connected onto the conductor between the first MOSFET switch and the second MOSFET switch, and the other end of the connecting assembly is connected onto the conductor between the third MOSFET switch and the fourth MOSFET switch. Each of the first MOSFET switch and the third MOSFET switch is provided with a first signal input end. Each of the second MOSFET switch and the fourth MOSFET switch is provided with a second signal input end. The first MOSFET switch, the second MOSFET switch, the third MOSFET switch and the fourth MOSFET switch are all zero-current switches. The first MOSFET switch and the fourth MOSFET switch are switched on and off at a same time. The second MOSFET switch and the third MOSFET switch are switched on and off at a same time. Moreover, a quality factor Q of the switch resonant cavity converter Lj (j is 1, 2, 3, . . . , 4) satisfies 0.1≤Q≤10.

Dead time, i.e., the time at which the first signal input end and the second signal input end are both off, and the first MOSFET switch, the second MOSFET switch, the third MOSFET switch and the fourth MOSFET switch are all on, exists between switch events in the switch resonant cavity converter Lj (j is 1, 2, 3, . . . , 4).

A capacitance value of the conversion switch capacitor is one order of magnitude greater than a capacitance value of the resonant capacitor. A capacitance value of the output switch capacitor is one order of magnitude greater than a capacitance value of the resonant capacitor.

The first MOSFET switch and the second MOSFET switch of the input assembly of the switch resonant cavity converter Lj (J is 1, 2, 3, 4) are respectively connected to two ends of each corresponding conversion switch capacitor Ci (i is 1, 2, 3, 4). The fourth MOSFET switch of the output assembly of the switch resonant cavity converter Lj (J is 1, 2, 3, 4) is connected to the lower end of the output switch capacitor. The third MOSFET switches of the output assemblies of the switch resonant cavity converters L1, L2 and L3 are connected to the upper end of the conversion switch capacitor C2. The third MOSFET switch of the output assembly of the switch resonant cavity converter L4 is connected to an upper end of the output switch capacitor C0.

During initial operation, the input voltage is equivalently divided into 5 parts which are stored into the conversion switch capacitors and the output switch capacitor.

Then, the switch resonant cavity converter L1 transmits the energy stored in C4 to C1 and C0 through a resonant cavity. The switch resonant cavity converter L2 transmits the energy stored in C3 to C1 and C0 through a resonant cavity. The switch resonant cavity converter L3 transmits the energy stored in C2 to C1 and C0 through a resonant cavity. The switch resonant cavity converter L4 transmits the energy stored in C1 to C0 through a resonant cavity. The final voltage transformation at the proportion of 8-1 from 48 V to 6 V can be achieved.

According to Embodiment 4, as shown in FIG. 7, a 2-1 power supply conversion topology of a multiphase switch capacitor resonant cavity conversion circuit with full-wave output rectification includes 1 conversion switch capacitor C1 and an output switch capacitor C0 which are sequentially connected in series through conductors, and are connected to two ends of an input power supply. A lower end of the output switch capacitor C0 is grounded, and two ends of the output switch capacitor C0 are connected with output interfaces. The power supply conversion topology further includes 1 switch resonant cavity converter L1.

The switch resonant cavity converter L1 includes an input assembly, an output assembly and a connecting assembly connected with the input assembly and the output assembly. The input assembly includes a first MOSFET switch and a second MOSFET switch connected in series through a conductor. The output assembly includes a third MOSFET switch and a fourth MOSFET switch connected in series through a conductor. The connecting assembly includes a resonant capacitor and a resonant inductor connected in series through a conductor. One end of the connecting assembly near the resonant capacitor is connected onto the conductor between the first MOSFET switch and the second MOSFET switch, and the other end of the connecting assembly is connected onto the conductor between the third MOSFET switch and the fourth MOSFET switch. Each of the first MOSFET switch and the third MOSFET switch is provided with a first signal input end. Each of the second MOSFET switch and the fourth MOSFET switch is provided with a second signal input end. The first MOSFET switch, the second MOSFET switch, the third MOSFET switch and the fourth MOSFET switch are all zero-current switches. The first MOSFET switch and the fourth MOSFET switch are switched on and off at a same time. The second MOSFET switch and the third MOSFET switch are switched on and off at a same time. Moreover, a quality factor Q of the switch resonant cavity converter L1 satisfies 0.1≤Q≤10.

Dead time, i.e., the time at which the first signal input end and the second signal input end are both off, and the first MOSFET switch, the second MOSFET switch, the third MOSFET switch and the fourth MOSFET switch are all on, exists between switch events in the switch resonant cavity converter Lj (j is 1, 2, 3, . . . , 4).

A capacitance value of the conversion switch capacitor is one order of magnitude greater than a capacitance value of the resonant capacitor. A capacitance value of the output switch capacitor is one order of magnitude greater than a capacitance value of the resonant capacitor.

The first MOSFET switch and the second MOSFET switch of the input assembly of the switch resonant cavity converter L1 are respectively connected to two ends of each corresponding conversion switch capacitor C1. The fourth MOSFET switch of the output assembly of the switch resonant cavity converter L1 is connected to the lower end of the output switch capacitor C0. The third MOSFET switch of the output assembly of the switch resonant cavity converters L1 is connected to an upper end of the output switch capacitor C0.

During initial operation, the input voltage is equivalently divided into 2 parts which are stored into the conversion switch capacitor C1 and the output switch capacitor C0. The switch resonant cavity converter L1 transmits the energy stored in C1 to C0 through a resonant cavity. The final voltage transformation at the proportion of 2-1 from 48 V to 24 V can be achieved.

As shown in FIG. 8, when the electric power transmission capacity of more than one power supply conversion topology SCTC of a multiphase switch capacitor resonant cavity conversion circuit with full-wave output rectification is required by the electric power transmission, a power supply conversion structure may be used. The power supply conversion structure includes N power supply conversion topologies SCTC of a multiphase switch capacitor resonant cavity conversion circuit with full-wave output rectification disposed in a parallel connection manner. A parallel architecture of the power supply conversion topologies SCTC of a multiphase switch capacitor resonant cavity conversion circuit with full-wave output rectification may also be expanded to various applications requiring a high-voltage conversion ratio and no current isolation.

As shown in FIG. 9, a power supply conversion structure includes a power supply conversion assembly and a point-of-load conversion assembly connected in series. The power supply conversion assembly includes a plurality of power supply conversion topologies SCTC of a multiphase switch capacitor resonant cavity conversion circuit with full-wave output rectification disposed in a parallel connection manner according to any one of the above embodiments, and the point-of-load conversion assembly includes a plurality of point-of-load converters PoL disposed in a parallel connection manner. The power supply conversion topologies SCTC of a multiphase switch capacitor resonant cavity conversion circuit with full-wave output rectification receive an input voltage and steps down the voltage to the middle bus voltage. Then, each point-of-load converter PoL receives the middle bus voltage to be used as the input, and generates a corresponding output stable voltage Vout, and its voltage value depends on the voltage requirements of a load.

The embodiments above only illustratively describe the principles and effects of the creation of the present invention, as well as some of the applied embodiments, and are not intended to limit the present invention; and it should be noted that for a person of ordinary skill in the art, several transformations and improvements can be made without departing from the creative idea of the present invention. These transformations and improvements belong to the protection scope of the present invention.

1. A power supply conversion topology of a multiphase switch capacitor resonant cavity conversion circuit with full-wave output rectification, comprising: at least k conversion switch capacitors and one output switch capacitor which are sequentially connected in series through conductors, and are connected to two ends of an input power supply, wherein, when a transformer ratio N is an even number, k=N/2; when the transformer ratio N is not an even number, k is a smallest integral greater than N/2; and a lower end of the output switch capacitor is grounded, and two ends of the output switch capacitor are connected with output interfaces; and further comprising: k switch resonant cavity converters, wherein, when the transformer ratio N is an even number, k=N/2; and when the transformer ratio N is not an even number, k is a smallest integral greater than N/2; and
each of the switch resonant cavity converters comprises an input assembly, an output assembly and a connecting assembly connected with the input assembly and the output assembly; the input assembly comprises a first MOSFET switch and a second MOSFET switch connected in series through a conductor; the output assembly comprises a third MOSFET switch and a fourth MOSFET switch connected in series through a conductor; the connecting assembly comprises a resonant capacitor and a resonant inductor connected in series through a conductor; one end of the connecting assembly near the resonant capacitor is connected onto the conductor between the first MOSFET switch and the second MOSFET switch, and the other end of the connecting assembly is connected onto the conductor between the third MOSFET switch and the fourth MOSFET switch; each of the first MOSFET switch and the third MOSFET switch is provided with a first signal input end; each of the second MOSFET switch and the fourth MOSFET switch is provided with a second signal input end; the first MOSFET switch and the fourth MOSFET switch are switched on and off at a same time; the second MOSFET switch and the third MOSFET switch are switched on and off at a same time; and a quality factor Q of the switch resonant cavity converter satisfies 0.1≤Q≤10; the first MOSFET switch and the second MOSFET switch of the input assembly of the switch resonant cavity converter are respectively connected to two ends of each corresponding conversion switch capacitor; the fourth MOSFET switch of the output assembly of the switch resonant cavity converter is connected to the lower end of the output switch capacitor; and the third MOSFET switch of the output assembly of the switch resonant cavity converter is connected to an upper end of the output switch capacitor or an upper end of any one of other conversion switch capacitors of the corresponding conversion switch capacitors of the switch resonant cavity converter at one side near the output switch capacitor.

2. The power supply conversion topology of a multiphase switch capacitor resonant cavity conversion circuit with full-wave output rectification according to claim 1, wherein dead time, i.e., the time at which the first signal input end and the second signal input end are both off, and the first MOSFET switch, the second MOSFET switch, the third MOSFET switch and the fourth MOSFET switch are all on, exists between switch events in the switch resonant cavity converter.

3. The power supply conversion topology of a multiphase switch capacitor resonant cavity conversion circuit with full-wave output rectification according to claim 2, wherein the first MOSFET switch, the second MOSFET switch, the third MOSFET switch and the fourth MOSFET switch are all zero current switches.

4. The power supply conversion topology of a multiphase switch capacitor resonant cavity conversion circuit with full-wave output rectification according to claim 1, wherein a capacitance value of the conversion switch capacitor is one order of magnitude greater than a capacitance value of the resonant capacitor.

5. The power supply conversion topology of a multiphase switch capacitor resonant cavity conversion circuit with full-wave output rectification according to claim 1, wherein a capacitance value of the output switch capacitor is one order of magnitude greater than a capacitance value of the resonant capacitor.

6. A power supply conversion structure, comprising at least two power supply conversion topologies of a multiphase switch capacitor resonant cavity conversion circuit with full-wave output rectification according to claim 1 disposed in a parallel connection manner.

7. A power supply conversion structure, comprising at least two transformer assemblies connected in series, wherein each of the transformer assemblies comprises one, two or more than two power supply conversion topologies of a multiphase switch capacitor resonant cavity conversion circuit with full-wave output rectification according to claim 1 disposed in a parallel connection manner.

8. A power supply conversion structure, comprising a power supply conversion assembly and a point-of-load conversion assembly connected in series, wherein the power supply conversion assembly comprises a plurality of power supply conversion topologies of a multiphase switch capacitor resonant cavity conversion circuit with full-wave output rectification according to claim 1 disposed in a parallel connection manner, and the point-of-load conversion assembly comprises a plurality of point-of-load converters disposed in a parallel connection manner.
